(19) United States
(12) Patent Application Publication
(10) Pub. No.: US 2006/0278859 A1
(43) Pub. Date: Dec. 14, 2006

(54) Lumber tool

(76) Inventor: Dennis Michael Fraley, Batavia, OH (US)

Correspondence Address: HASSE & NESBITT LLC, 8837 CHAPEL SQUARE DRIVE, SUITE C, CINCINNATI, OH, 45249, US

(21) Appl. No.: 11/150,375

(22) Filed: Jun. 10, 2005

(51) Int. Cl. B66F 3/00

(52) U.S. Cl. 254/17

(57) ABSTRACT

A lumber tool for forcing a wooden member supported on a supporting member into fixed position with an adjoining wooden member attached to the supporting member. The tool comprises a U-shaped frame conforming to the top edge and adjacent sides of the supporting member; a locking member attached to the frame for releasably holding the frame in fixed position relative to the supporting member; a push bar slideably attached to the frame for engaging the wooden member to move it into fixed position with the adjoining wooden member; and a leverage handle pivotally attached to the frame and to the push bar so that when the locking member is engaged to hold the frame in fixed position relative to the supporting member and the leverage handle is moved forward, the push bar slides and engages the wooden member and moves it into fixed position with the adjoining wooden member so that it can be affixed to the supporting member. In one embodiment, the push bar has a surface for engaging the wooden member that is perpendicular to the direction of movement of the leverage handle and an opposite surface for engaging the wooden member that forms a 45 degree angle relative to the direction of movement of the leverage handle.

### FIELD OF THE INVENTION

This invention relates to a lumber tool. More particularly, the invention relates to a hand lumber tool useful for forcing boards, sheathing and other wooden members, especially when warped or misshapen, into fixed position with an adjoining wooden member already attached to a supporting member such as a joist. The invention is thus useful in the construction of floors or decking and the installation of sheathing for roof construction.

### BACKGROUND OF THE INVENTION

Generally, two types of lumber tools have been used for installing decking or sheathing: devices utilizing spikes or prongs to engage the tool with supporting members; and devices utilizing a mechanism for clamping or wedging the tool to supporting members.

U.S. Pat. No. 3,524,623 to Campbell, discloses a tool having prongs that dig into the subflooring in order to exert force on the boards being laid. U.S. Pat. No. 3,331,584 to Schwartz discloses a cam-lever type floor jack pivoting about spiked members that dig into the underside of the joist. U.S. Pat. No. 3,203,668 to Pitsenbarger relates to a flooring jack for installing tongue and groove boards. This device relies on a pointed end of the tool being driven into the subfloor and supplying leverage for a push rod. U.S. Pat. No. 2,823,011 to Jones shows a sliding tool that is anchored to a stud or similar member with a prong.

U.S. Pat. No. 5,139,231 to Temple discloses a device that wedges to the supporting member via slits through the device and the supporting member itself. U.S. Pat. No. 2,780,437 discloses a device that clamps to the joist. U.S. Pat. No. 2,625,368 to Warner relates to a jack that also depends upon being clamped to the joist. U.S. Pat. No. 2,351,691 to Mansir relates to a lumber puller that relies on cams to engage and clamp the tool to the sides of a joist.

The prong and spike type devices typically do considerable damage to the joist or subfloor with which they are used. Such devices mar the wood and create splinters that may be unsightly as well as dangerous on a construction such as an open deck. Damage resulting from use of said devices may also contribute to wood rot over time, weakening structural integrity. On the other hand, clamping devices are mechanically complex and subject to bending and breaking, particularly when considerable force is needed in the case of a badly warped board. Some wedge devices involve cutting of slits into the supporting members, which requires additional time on the part of the worker and can damage the supporting members.

Thus, there is a continuing need for a simple and inexpensive lumber tool that can be used to quickly and easily force wooden members, particularly warped wooden members, into fixed position without significantly marring the surface of the supporting members.

### SUMMARY OF THE INVENTION

The present invention relates to a lumber tool for forcing a wooden member supported on a supporting member into fixed position with an adjoining wooden member attached to the supporting member, said lumber tool comprising:
a. a U-shaped frame conforming to the top edge and adjacent sides of the supporting member and having a threaded hole formed in a side of the frame;
b. a locking member attached to the frame for releasably holding the frame in fixed position relative to the supporting member, said locking member comprising:
   1) a flat surface for contacting the supporting member without significantly marring its surface when the frame is held in fixed position relative to the supporting member,
   2) an adjacent threaded end for engaging the threaded hole in the frame to hold the frame in fixed position relative to the supporting member, and
   3) a locking handle for engaging and disengaging the locking member in fixed position relative to the supporting member;
c. a push bar slideably attached to the frame for engaging the wooden member so as to move it into fixed position with the adjoining wooden member affixed to the supporting member; and
d. a leverage handle pivotally attached to the frame and to the push bar so that when the locking member is engaged to hold the frame in fixed position relative to the supporting member and the leverage handle is moved forward, the push bar slides and engages the wooden member and moves it into fixed position with the adjoining wooden member so that it can be affixed to the supporting member.

The invention also relates to a lumber tool as described above further comprising a guide bar attached to the push bar and to a leverage arm that is attached to the leverage handle; and guide members that keep the direction of movement of the guide bar, the push bar, and the leverage handle substantially parallel to and above the supporting member.

In one embodiment, the locking member locks the frame to the supporting member with about a 90 degree turn of the locking handle. In another embodiment, the push bar has a surface for engaging the wooden member that is perpendicular to the direction of movement of the leverage handle and an opposite surface for engaging the wooden member that forms a 45 degree angle relative to the direction of movement of the leverage handle. In yet another embodiment, the guide bar engages the frame to stop forward and backward motion of the leverage handle.

### BRIEF DESCRIPTION OF THE DRAWINGS

FIG. 1 is a perspective view of a lumber tool of the present invention.

FIG. 2 is another perspective view of the lumber tool of FIG. 1.

FIG. 3 is a perspective view of another lumber tool of the invention.

FIG. 4 is a top view of the U-shaped frame of the lumber tool of FIG. 1.

FIG. 5 is a side view of the frame of FIG. 4.

FIG. 6 is a front view of the frame of FIG. 4.

FIG. 7 is a top view of the push bar of the lumber tool of FIG. 1.

FIG. 8 is a side view of the push bar of FIG. 7.

FIG. 9 is an end view of the push bar of FIG. 7.

FIG. 10 is a top view of the guide bar of the lumber tool of FIG. 1.

FIG. 11 is a side view of the guide bar of FIG. 10.

FIG. 12 is a side view of the leverage handle of the lumber tool of FIG. 1.

FIG. 13 is a top view of the leverage handle of FIG. 12.

FIG. 14 is a side view of the leverage arm of the lumber tool of FIG. 1.

FIG. 15 is a top view of the locking member of the lumber tool of FIG. 1.

FIG. 16 is a top view of the U-shaped frame of the lumber tool of FIG. 3.

FIG. 17 is a side view of the frame of FIG. 16.

FIG. 18 is a front view of the frame of FIG. 16.

FIG. 19 is a top view of a lumber tool of the invention showing its operation to hold a deck board in place so that it can be attached to a supporting member.

FIG. 20 is a top view of two lumber tools of the invention showing their operation to hold deck boards in place so they can be attached to supporting members at about 45 degree angles.

### DETAILED DESCRIPTION OF THE INVENTION

The present invention provides a lumber tool that is simple in construction, yet enables the application of substantial force for assembling wooden members, including warped or deformed boards, and maintaining them in a fixed position with adjoining wooden members so they can be fastened to supporting members. The tool is useful for forcing wooden members such as boards, sheathing and like materials that are supported on a joist, rafter or other supporting member into close proximity or contact with one another. When this is accomplished, the wooden member can be fastened to the supporting member. The tool can accommodate the varying width and thickness of boards, sheathing, joists, rafters and other wooden members with which it is used. The tool also minimizes or eliminates damage to the materials being constructed. In particular, the tool comprises a locking member that has a flat surface for contacting the supporting member without significantly marring its surface while holding the frame in fixed position relative to the supporting member. The tool allows a single worker to more quickly and easily install even warped or misshapen lumber without damaging the materials. For example, the tool can quickly and easily be locked in place on a joist, used to force a board in fixed position with an adjoining board fixed to the joist, and then unlocked and slid down the joist. The process can be repeated on one joist, and the tool can easily be moved to an adjoining joist where the process can be repeated, until the construction is completed. The tool thus can provide substantial savings in construction time, labor and/or materials, and thus lower construction costs.

The foregoing and other advantages of the invention will become apparent from the following disclosure in which embodiments of the invention are described in detail and illustrated in the accompanying drawings. Variations in size, shape and structural features, and arrangement of parts may be made without departing from the scope of the invention.

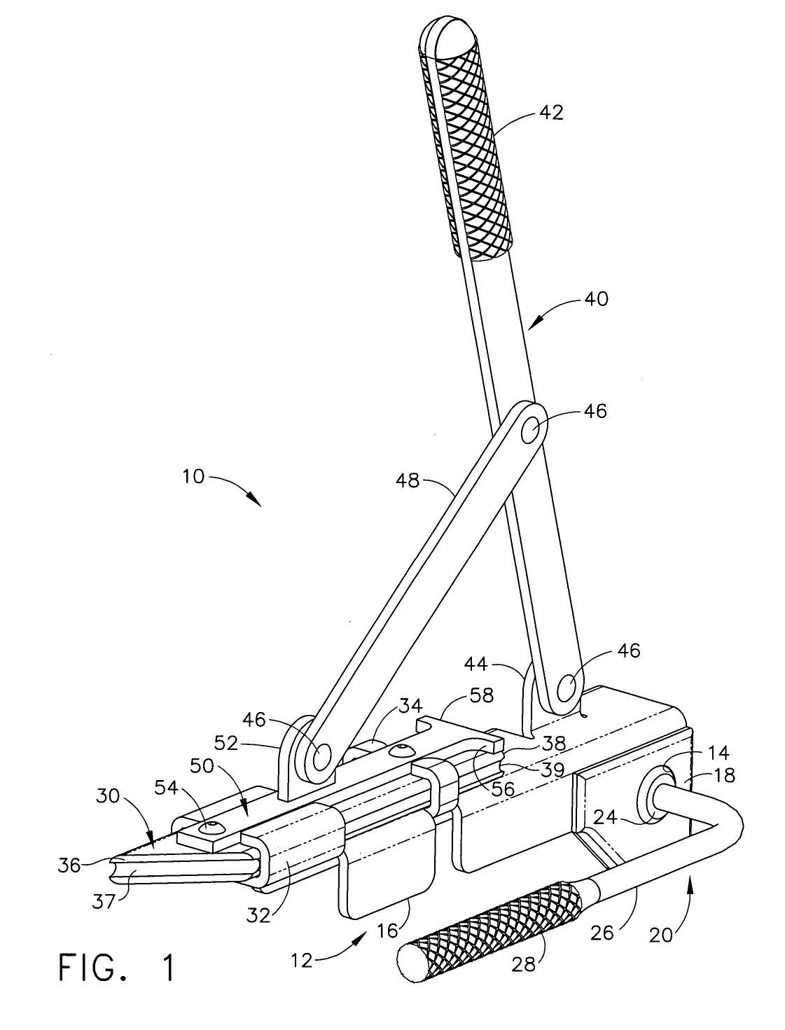

FIG. 1 illustrates a lumber tool 10 of the invention. The tool comprises a U-shaped frame or housing, such as frame 12, which generally conforms to the shape of a joist, rafter or other supporting member. In one embodiment, the frame has a U-shaped configuration conforming generally in shape to the edge and adjacent sides of the supporting member. The frame has a threaded hole, such as threaded hole 14, and two downwardly extending legs, such as legs 16, joined by a top member. The frame conforms to the top edge and adjacent sides of the joist or other supporting member. In FIG. 1, the frame 12 also has a plate 18 on one side to provide a thicker side region to form the threaded hole 14. Such a plate is optional and not necessary if the side of the frame is sufficiently thick to form the threads in the hole. The frame is typically is made of steel, aluminum or other hard, durable material.

The tool also typically comprises one or more guide members to control the direction of motion and the force applied to the wooden member by the push bar and the leverage handle. The guide members typically keep the direction of movement of the guide bar, the push bar, and the leverage handle substantially parallel to and above the supporting member. This maximizes the force that can be applied to the wooden member to force it into fixed position. Moreover, since the frame, leverage handle, guide bar and push bar are typically centered over the supporting member, the tool remains stable even when substantial force is applied to force the wooden member into fixed position.

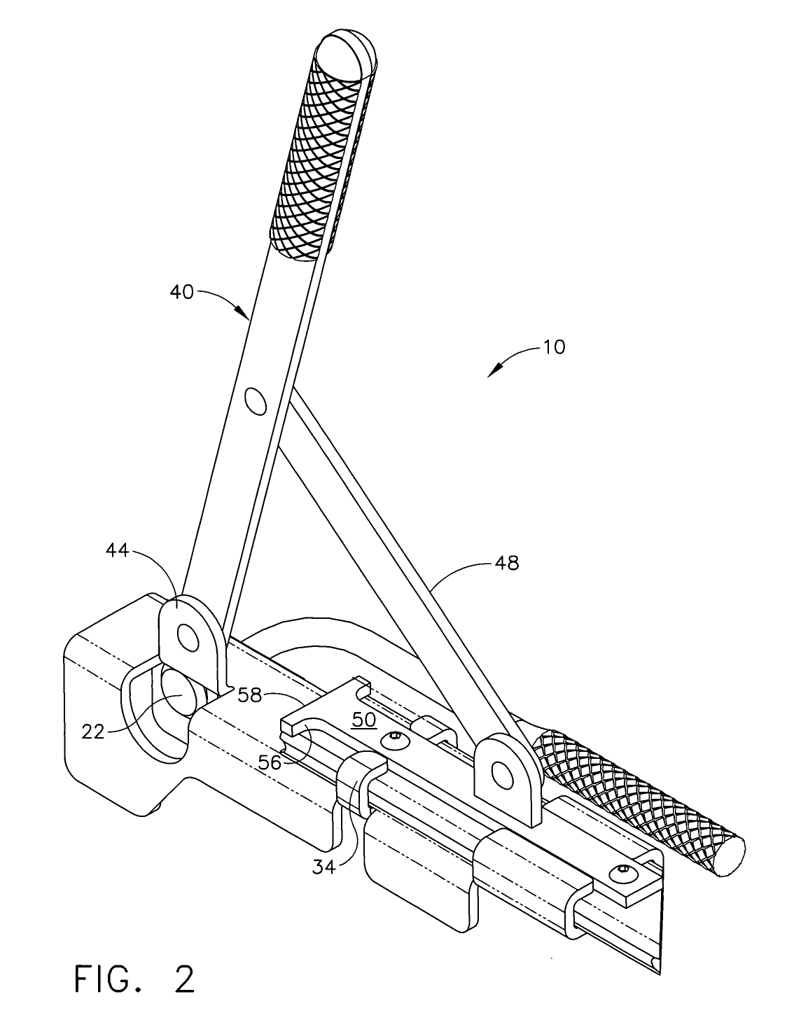

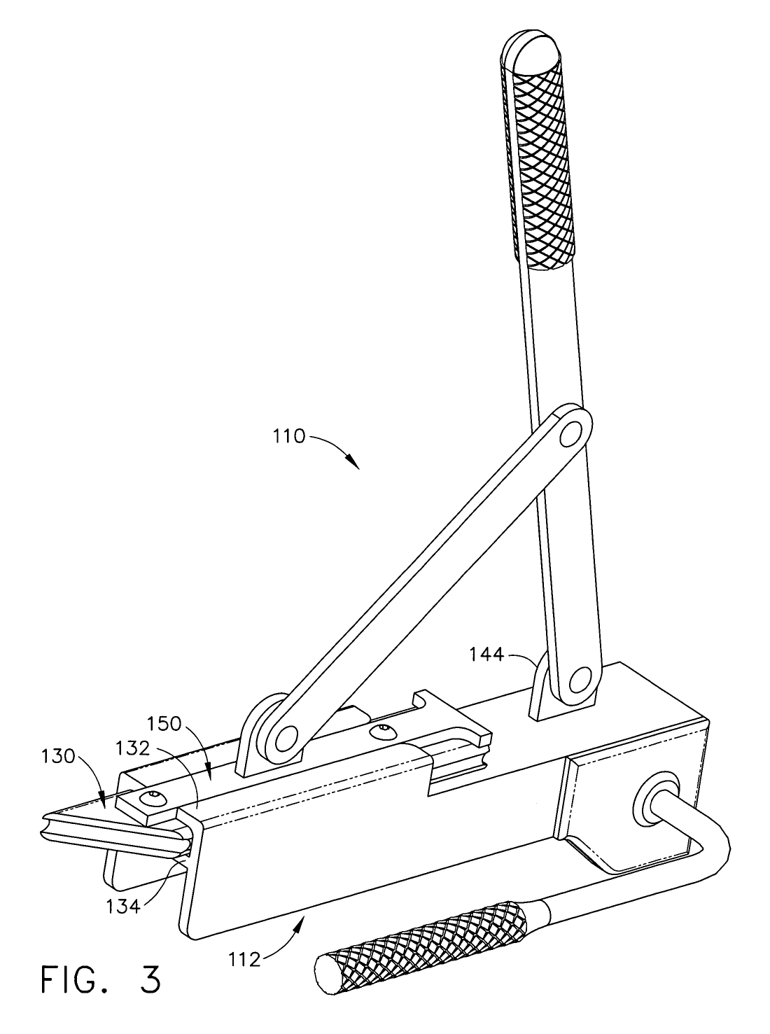

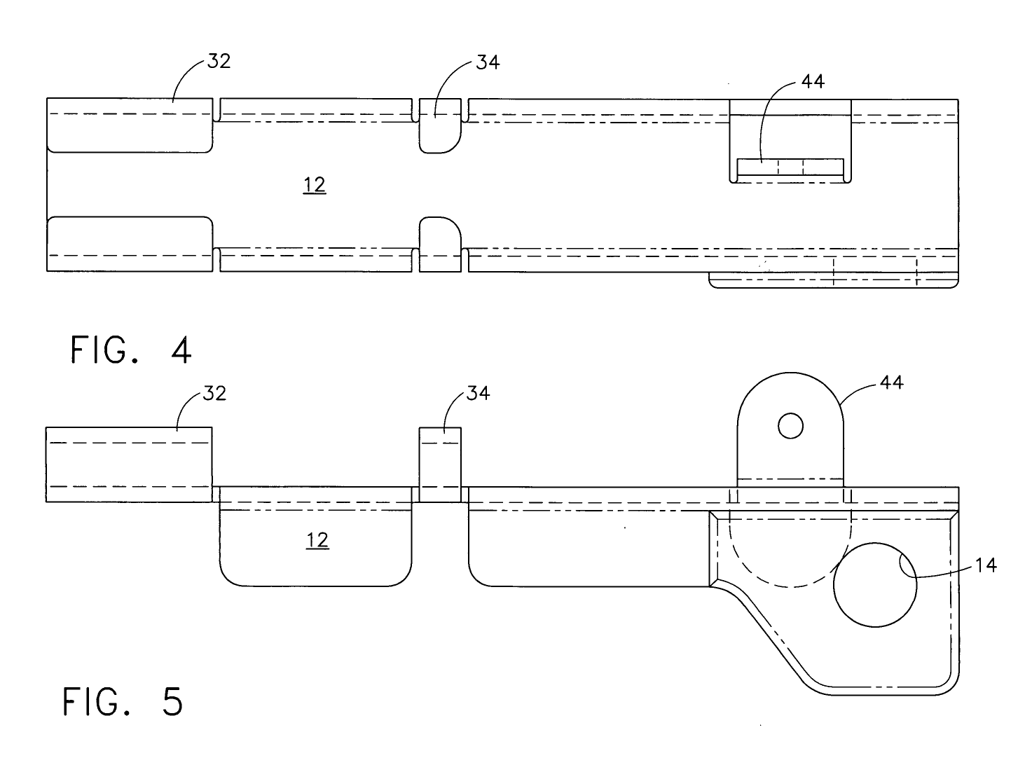

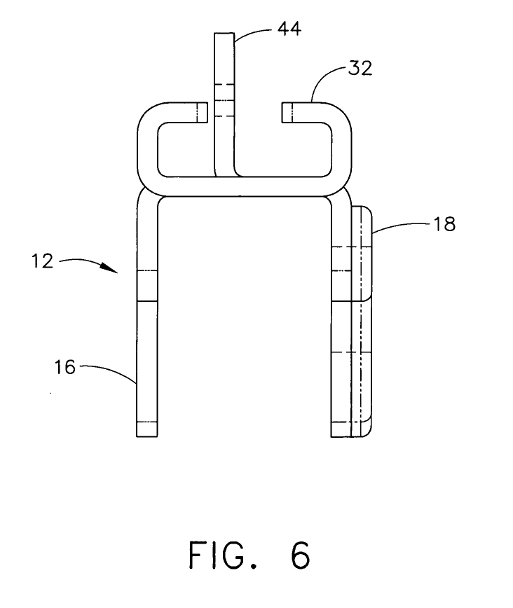

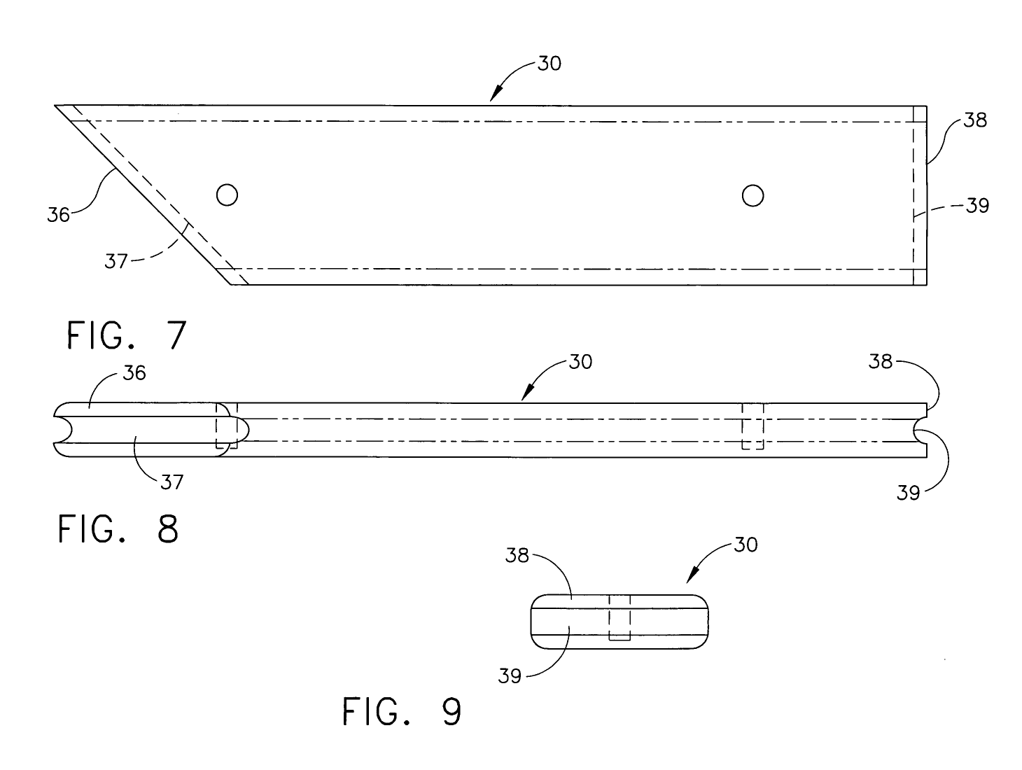

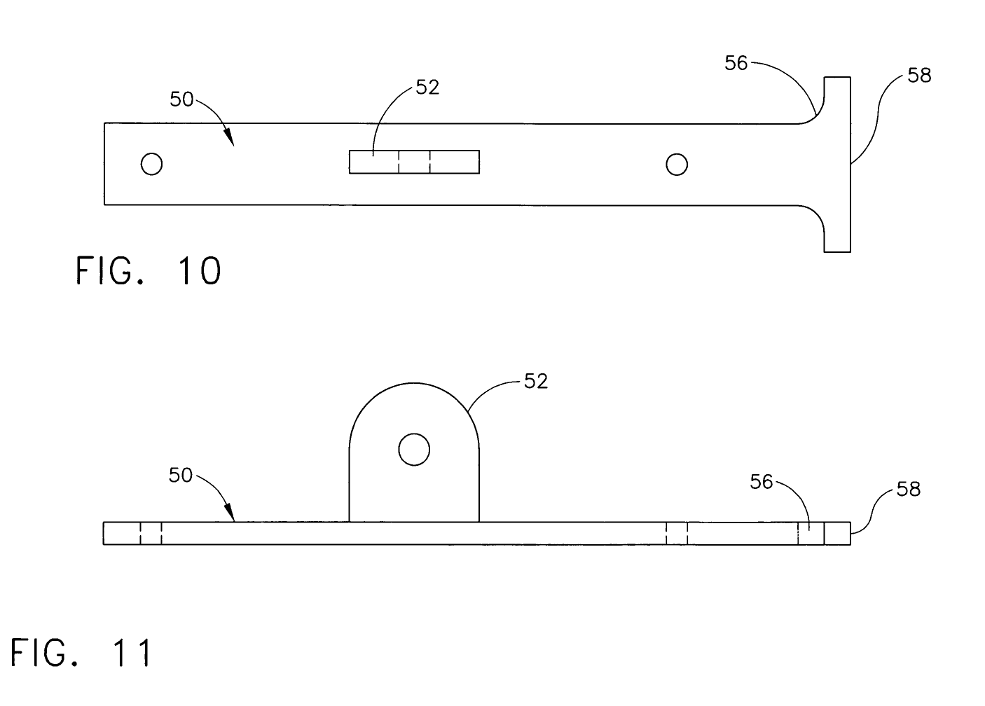

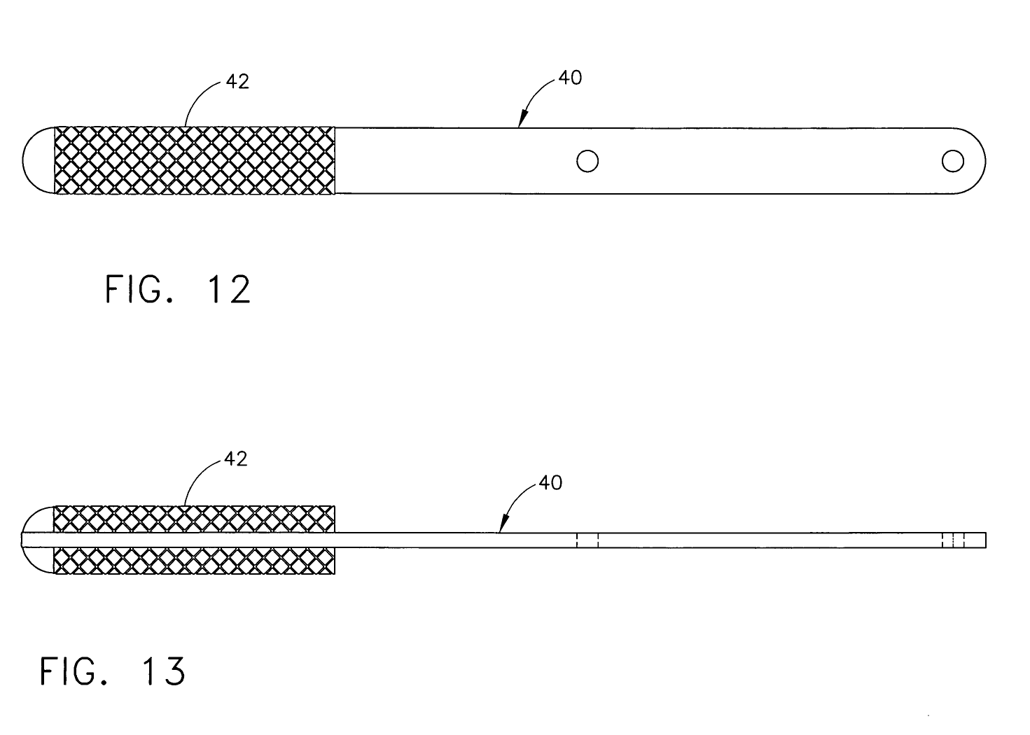

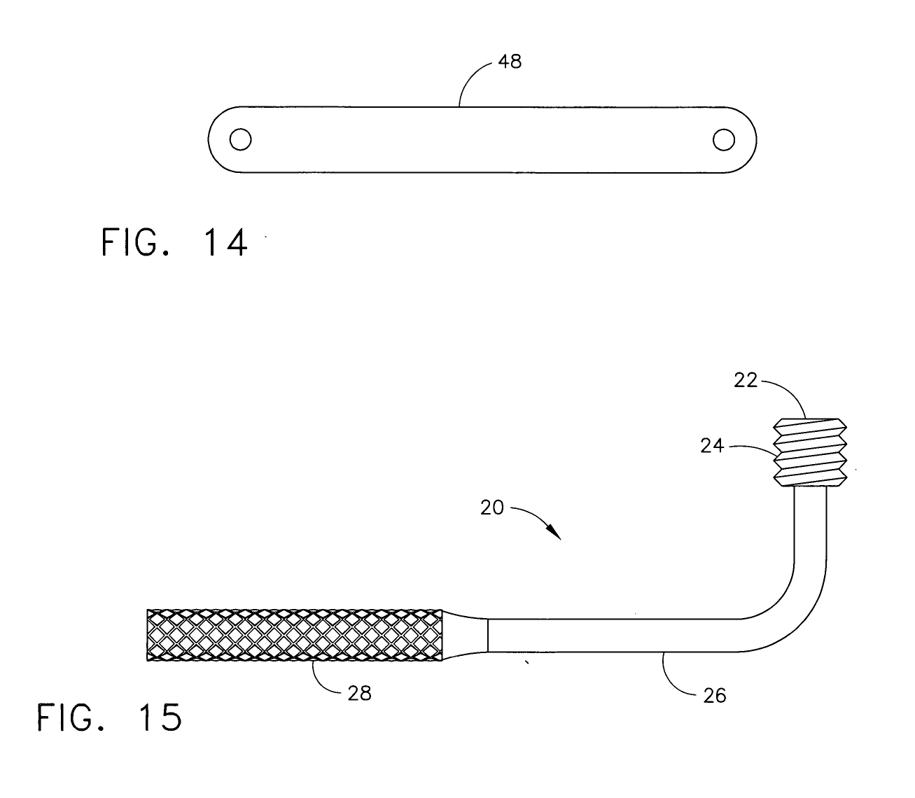

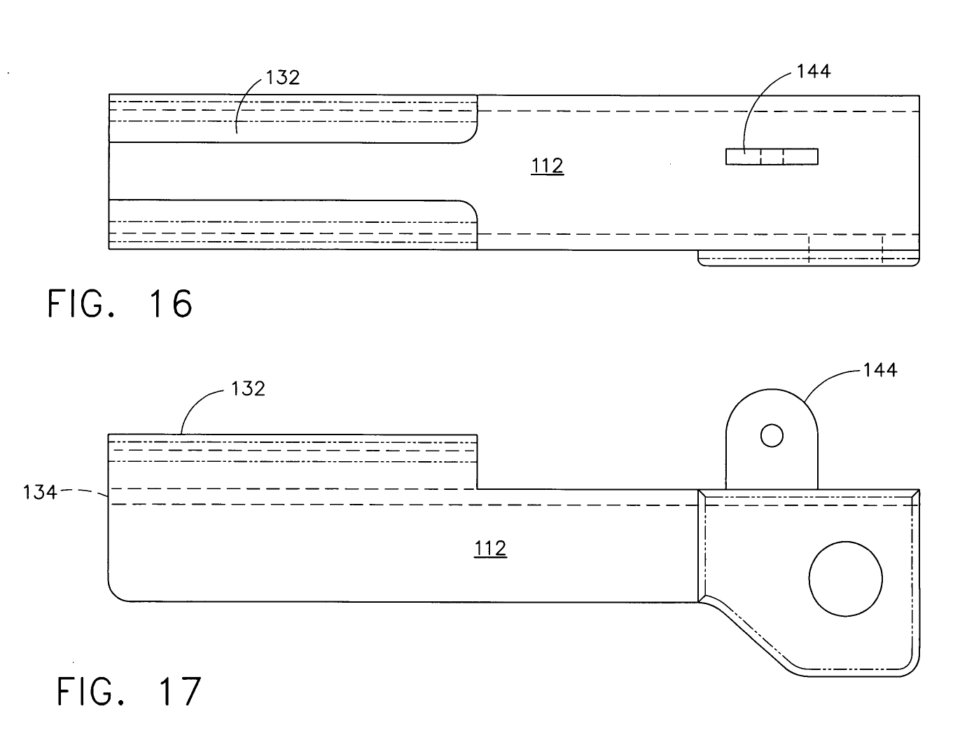

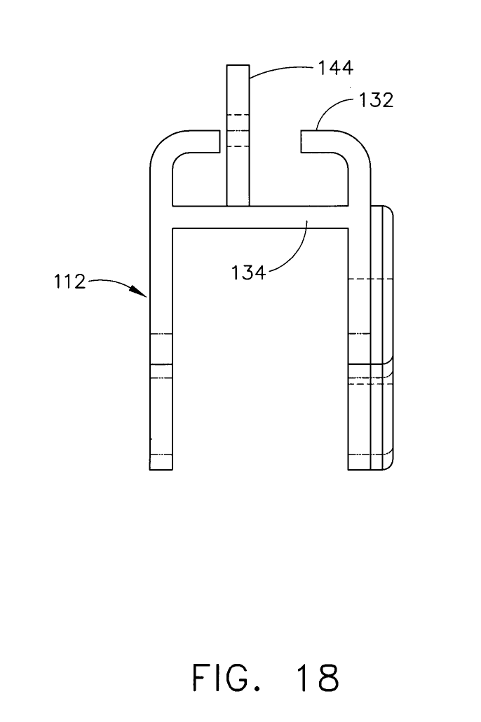

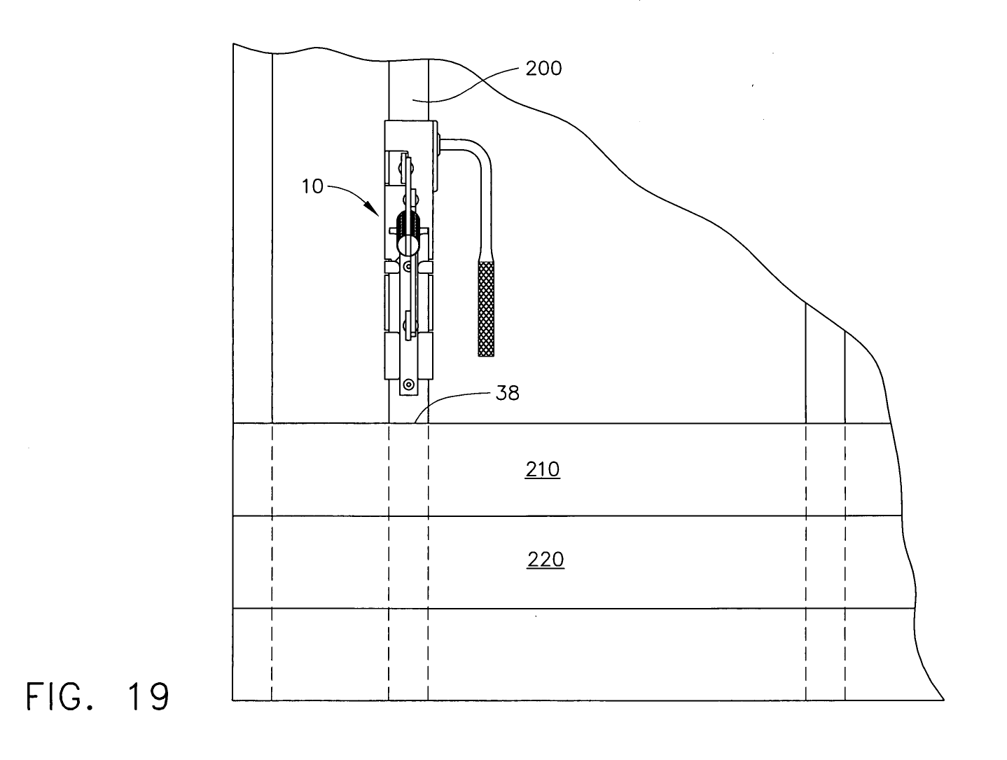

In FIG. 1, the frame comprises front guide members 32 and rear guide members 34, which can be made by cutting (e.g., laser cutting) sections of the frame and bending the sections upward and then toward the longitudinal centerline of the tool. The guide members 32 and 34 are also shown in FIGS. 2 and 4-6. FIG. 3 shows another U-shaped frame 112 of the invention comprising guide members 132 and a support member 134. FIGS. 16-18 show top, side and front views of frame 112 and guide members 132.

The tool also comprises a locking member, such as locking member 20, attached to the frame for releasably holding the frame in fixed position relative to the supporting member. The locking member fixes the frame of the tool to a supporting member and keeps the tool stationery by providing a locking force sufficient to offset the force required to manipulate the wooden member being fixed into place. The locking member has a flat surface, such as flat surface 22 shown in FIGS. 2 and 15, for contacting the supporting member without significantly marring its surface when the frame is held in fixed position relative to the supporting member. The locking member also has an adjacent threaded end, such as threaded end 24 shown in FIGS. 1 and 15, for engaging the threaded hole in the frame to hold the frame in fixed position relative to the supporting member. The locking member further comprises a locking handle, such as locking handle 26, for engaging and disengaging the locking member in fixed position relative to the supporting member. In one embodiment, turning the locking handle about 90 degrees (about ¼ turn of the handle, for example, from a vertical position to a horizontal position) locks the frame against the supporting member. The locking handle typically has a gripping surface, such as grip surface 28 shown in the figures.

The tool also comprises a leverage handle, such as leverage handle 40, pivotally attached to the frame. In FIG. 1, the handle is attached to attachment plate 44 of the frame with a pivot pin 46. Plate 44 is typically cut from the frame, for example by laser cutting, and bent upward into a vertical position. The handle may be joined to the frame with other suitable fastening means such as nuts and bolts. A suitable bushing can be used between pivot pin 46 and plate 44 to minimize wear on the pivot pin. Alternatively, the leverage handle may be joined to the frame using one or more legs with pivot pins through each of the legs. Typically, the direction of movement of the leverage handle is substantially parallel to and above the supporting member. The leverage handle typically has a gripping surface, such as grip surface 42 shown in the figures.

The tool further comprises a push bar, such as push bar 30 shown in FIG. 1. The push bar is slideably attached to the frame for engaging the wooden member supported on the supporting member so as to move the wooden member into fixed position with the adjoining wooden member affixed to the supporting member. The push bar typically is attached to a leverage arm that is attached to the leverage handle, which is attached to the frame. For example, in FIG. 1, push bar 30 is attached to guide bar 50, which is attached to leverage arm 48, which is attached to leverage handle 40, which is attached to frame 12. The push bar may be attached directly or indirectly to the frame. As used herein, the word “attached” is intended to cover all means for connecting the identified components, including using protrusions, clips or extensions that connect the component and force it in one direction or another when the leverage handle is pulled or pushed forward or backward.

The push bar typically is attached to the frame in a manner such that it can easily slide on the surface of the frame. The leverage handle is pivotally attached to the frame and to the push bar so that when the locking member is engaged to hold the frame in fixed position relative to the supporting member and the leverage handle is moved forward, the push bar slides and engages the wooden member supported on the supporting member and moves it into fixed position with the adjoining wooden member so that it can be affixed to the supporting member. The handle is also used to maintain the wooden member in proximity or in contact with the affixed wooden member while it is being attached to the supporting member. The push bar typically is pivotally attached to the leverage handle so as generally to be in the plane of the wooden member to be held in place. The pivotal attachment to the leverage handle allows the push bar to be used with boards, sheathing and the like having a wide ranges of thickness.

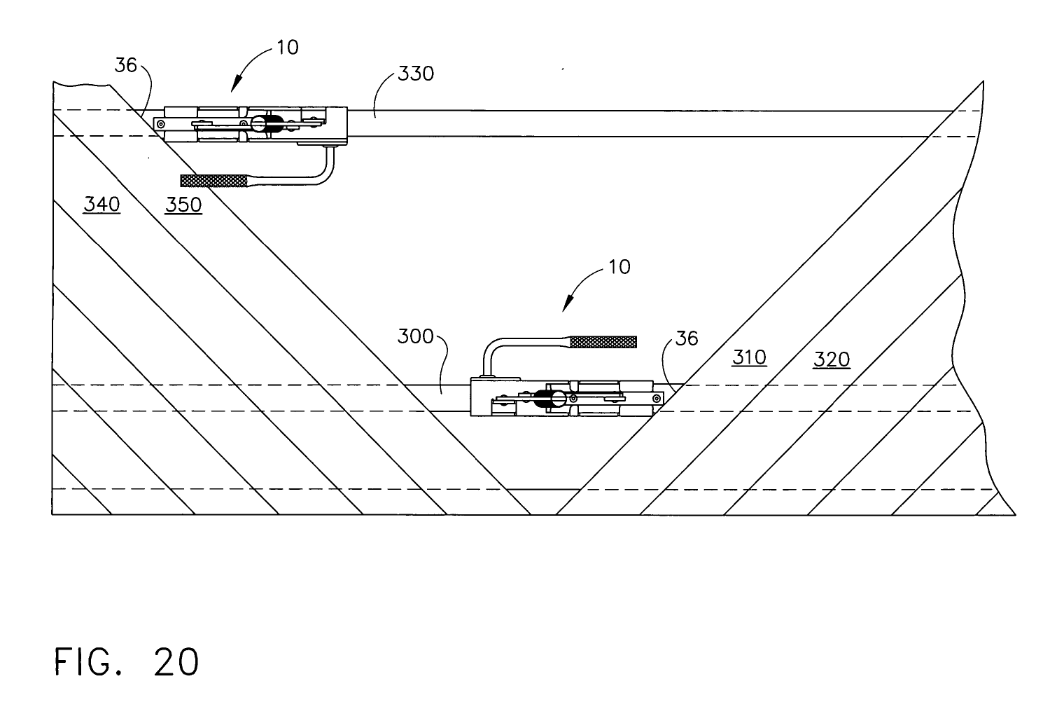

In one embodiment, the push bar has a surface, such as surface 38 in FIG. 1, for engaging the wooden member that is perpendicular to the direction of movement of the leverage handle and an opposite surface, such as surface 36, for engaging the wooden member that forms a 45 degree angle relative to the direction of movement of the leverage handle. In another embodiment, the push bar can be turned over to provide a surface for engaging the wooden member that forms a different 45 degree angle relative to the direction of movement of the leverage handle. For example, the bolts 54 connecting push bar 30 and guide bar 50 in FIG. 1 can be removed, the guide bar lifted up, and the push bar turned over and reattached to the guide bar to provide a different 45 degree angle relative to the direction of motion of the leverage handle. This allows the application of wooden members to supporting members at different 45 degree angles such as shown in FIG. 20. The push bar may also have a surface that has a groove therein, such as groove 37 or groove 39 shown in FIG. 1, for engaging a wooden member having a matching tongue surface. This embodiment is particularly useful when constructing floors inside houses or other buildings.

The push bar is typically attached to a guide bar, such as guide bar 50 shown in FIG. 1, which is attached to a leverage arm, such as leverage arm 48, which is attached to the leverage handle. For example, guide bar 50 comprises an attachment plate 52 that is pivotally attached to leverage arm 48, which is pivotally attached to leverage handle 40. The attachment can be accomplished using pivot pins, such as pivot pins 46, or other suitable fastening means such as nuts and bolts. In one embodiment, the guide bar engages the frame to stop forward and backward motion of the leverage handle. For example, in the tool of FIG. 1, the back edge 58 of guide bar 50 contacts the front edge of the attachment plate 44 of the frame to limit the rearward travel of the leverage handle 40 (and also push bar 30), typically when the leverage handle is in a vertical position. The curved surface 56 of guide bar 50 contacts the rear edge of the guide member 34 of the frame to limit the forward travel of the leverage handle 40 (and also push bar 30). Similarly, in the tool of FIG. 3, the back edge of guide bar 150 contacts the front edge of the attachment plate 144 of the frame to limit the rearward travel of the leverage handle (and also push bar 130), and the curved surface of guide bar 150 contacts the rear edge of the guide member 132 of the frame to limit the forward travel of the leverage handle (and also push bar 130).

The operation of the lumber tool 10 is illustrated in FIGS. 19 and 20. In FIG. 19, the U-shaped frame of tool 10 is placed over the supporting member such as joist 200, with the locking handle in a perpendicular orientation. The operator pulls the locking handle downward to urge the flat surface of the locking member against the side of the joist with sufficient force to hold the frame in fixed position relative to the joist and to keep the frame from sliding along the joist. The operator then pulls the leverage handle forward so that the push bar slides and surface 38 engages the board 210 and moves it into fixed position with the adjoining board 220, which has already been nailed or otherwise attached to joist 200. In the case of a warped board, greater forward force on the leverage handle will produce a proportional forward force on the board 210 to force it against board 220. FIG. 20 shows the application of boards 310 and 350 into fixed position with the adjoining boards 320 and 340, respectively, using push bars that provide 45 degree angles via surfaces 36.

It is to be understood that although the present invention has been described with certain embodiments and examples, modifications to the design and operation of the lumber tool may be apparent to those skilled in the art, and such modifications and variations are considered to be within the scope of the invention and the appended claims.

I claim:

1. A lumber tool for forcing a wooden member supported on a supporting member into fixed position with an adjoining wooden member attached to the supporting member, said lumber tool comprising:
a. a U-shaped frame conforming to the top edge and adjacent sides of the supporting member and having a threaded hole formed in a side of the frame;
b. a locking member attached to the frame for releasably holding the frame in fixed position relative to the supporting member, said locking member comprising:
1) a flat surface for contacting the supporting member without significantly marring its surface when the frame is held in fixed position relative to the supporting member,
2) an adjacent threaded end for engaging the threaded hole in the frame to hold the frame in fixed position relative to the supporting member, and
3) a locking handle for engaging and disengaging the locking member in fixed position relative to the supporting member;
c. a push bar slideably attached to the frame for engaging the wooden member so as to move it into fixed position with the adjoining wooden member affixed to the supporting member; and
d. a leverage handle pivotally attached to the frame and to the push bar so that when the locking member is engaged to hold the frame in fixed position relative to the supporting member and the leverage handle is moved forward, the push bar slides and engages the wooden member and moves it into fixed position with the adjoining wooden member so that it can be affixed to the supporting member.

2. A tool according to claim 1 wherein the direction of movement of the leverage handle is substantially parallel to and above the supporting member.

3. A tool according to claim 1 wherein the locking handle and the leverage handle have a gripping surface.

4. A tool according to claim 1 wherein the push bar has a surface for engaging the wooden member that is perpendicular to the direction of movement of the leverage handle and an opposite surface for engaging the wooden member that forms a 45 degree angle relative to the direction of movement of the leverage handle.

5. A tool according to claim 4 wherein the push bar can be turned over to provide a surface for engaging the wooden member that forms a different 45 degree angle relative to the direction of movement of the leverage handle.

6. A tool according to claim 1 wherein the push bar has a surface that has a groove therein for engaging a wooden member having a matching tongue surface.

7. A tool according to claim 1 wherein the push bar is attached to a guide bar that is attached to a leverage arm that is attached to the leverage handle.

8. A tool according to claim 7 wherein the direction of movement of the leverage handle, the guide bar, and the push bar is substantially parallel to and above the supporting member.

9. A tool according to claim 1 wherein the push bar is attached to a guide bar that engages the frame to stop forward and backward motion of the leverage handle.

10. A tool according to claim 7 wherein the frame comprises guide members that keep the direction of movement of the guide bar, the push bar, and the leverage handle substantially parallel to and above the supporting member.

11. A tool according to claim 10 wherein the guide bar engages the frame to stop forward and backward motion of the leverage handle.

12. A tool according to claim 11 wherein the push bar has a surface for engaging the wooden member that is perpendicular to the direction of movement of the leverage handle and an opposite surface for engaging the wooden member that forms a 45 degree angle relative to the direction of movement of the leverage handle.

13. A tool according to claim 1 wherein the locking member locks the frame to the supporting member with about a 90 degree turn of the locking handle.

14. A tool according to claim 12 wherein the locking member locks the frame to the supporting member with about a 90 degree turn of the locking handle.

15. A lumber tool for forcing a wooden member supported on a supporting member into fixed position with an adjoining wooden member attached to the supporting member, said lumber tool comprising:
a. a U-shaped frame conforming to the top edge and adjacent sides of the supporting member and having a threaded hole formed in a side of the frame;
b. a locking member attached to the frame for releasably holding the frame in fixed position relative to the supporting member, said locking member comprising:
1) a flat surface for contacting the supporting member without significantly marring its surface when the frame is held in fixed position relative to the supporting member,
2) an adjacent threaded end for engaging the threaded hole in the frame to hold the frame in fixed position relative to the supporting member, and
3) a locking handle for engaging and disengaging the locking member in fixed position relative to the supporting member;
c. a push bar slideably attached to the frame for engaging the wooden member so as to move it into fixed position with the adjoining wooden member affixed to the supporting member;
d. a leverage handle pivotally attached to the frame and to the push bar so that when the locking member is engaged to hold the frame in fixed position relative to the supporting member and the leverage handle is moved forward, the push bar slides and engages the wooden member and moves it into fixed position with the adjoining wooden member so that it can be affixed to the supporting member;
e. a guide bar attached to the push bar and to a leverage arm that is attached to the leverage handle; and
f. guide members that keep the direction of movement of the guide bar, the push bar, and the leverage handle substantially parallel to and above the supporting member.

16. A tool according to claim 15 wherein the push bar has a surface for engaging the wooden member that is perpendicular to the direction of movement of the leverage handle and an opposite surface for engaging the wooden member that forms a 45 degree angle relative to the direction of movement of the leverage handle.

17. A tool according to claim 16 wherein the push bar can be turned over to provide a surface for engaging the wooden member that forms a different 45 degree angle relative to the direction of movement of the leverage handle.

18. A tool according to claim 17 wherein the guide bar engages the frame to stop forward and backward motion of the leverage handle.

19. A tool according to claim 18 wherein the locking member locks the frame to the supporting member with about a 90 degree turn of the locking handle.

20. A lumber tool for forcing a wooden member supported on a supporting member into fixed position with an adjoining wooden member attached to the supporting member, said lumber tool comprising:
a. a U-shaped frame conforming to the top edge and adjacent sides of the supporting member and having a threaded hole formed in a side of the frame;
b. a locking member attached to the frame for releasably holding the frame in fixed position relative to the supporting member, said locking member comprising:
1) a flat surface for contacting the supporting member without significantly marring its surface when the frame is held in fixed position relative to the supporting member,
2) an adjacent threaded end for engaging the threaded hole in the frame to hold the frame in fixed position relative to the supporting member, and
3) a locking handle for engaging and disengaging the locking member in fixed position relative to the supporting member;
wherein the locking member locks the frame to the supporting member with about a 90 degree turn of the locking handle;
c. a push bar slideably attached to the frame for engaging the wooden member so as to move it into fixed position with the adjoining wooden member affixed to the supporting member, said push bar having a surface for engaging the wooden member that is perpendicular to the direction of movement of the leverage handle and an opposite surface for engaging the wooden member that forms a 45 degree angle relative to the direction of movement of the leverage handle;
d. a leverage handle pivotally attached to the frame and to the push bar so that when the locking member is engaged to hold the frame in fixed position relative to the supporting member and the leverage handle is moved forward, the push bar slides and engages the wooden member and moves it into fixed position with the adjoining wooden member so that it can be affixed to the supporting member;
e. a guide bar attached to the push bar and to a leverage arm that is attached to the leverage handle, wherein the guide bar engages the frame to stop forward and backward motion of the leverage handle; and
f. guide members that keep the direction of movement of the guide bar, the push bar, and the leverage handle substantially parallel to and above the supporting member.
